(19) United States
(12) Patent Application Publication
(10) Pub. No.: US 2005/0181749 A1
(43) Pub. Date: Aug. 18, 2005

(54) Method and apparatus for compensating phase errors in a base station system

(76) Inventor: Tae-Young Lee, Seongnam-si (KR)

Correspondence Address: Robert E. Bushnell, Suite 300, 1522 K Street, N.W., Washington, DC, 20005-1202, US

(21) Appl. No.: 10/995,417

(22) Filed: Nov. 24, 2004

(30) Foreign Application Priority Data
Jan. 30, 2004 (KR) 2004-6343

(51) Int. Cl. H04B 1/04

(52) U.S. Cl. 455/126; 455/115.1; 455/561

(57) ABSTRACT

An apparatus and a method for compensating phase errors in a wireless BSS. The invention compensates I/Q signal imbalances and phase errors occurring in base station systems each having a direct conversion transmitter according to the respective systems as well as continuously monitor and compensate the degree of the I/Q signal imbalances through its own feedback path in order to overcome phase distortion and I/Q signal imbalance occurring at RF terminals of the respective wireless base station systems each having a direct conversion transmitter, thereby ensuring phase linearity to the base station systems using the direct conversion transmitter while improving its performance.

### CLAIM OF PRIORITY

This application makes reference to, incorporates the same herein, and claims all benefits accruing under 35 U.S.C. 119 from an application for METHOD AND APPARATUS FOR COMPENSATING PHASE ERROR IN BASE STATION SYSTEM earlier filed in the Korean Intellectual Property Office on 30 January, 2004 and there duly assigned Serial No. 2004-6343.

### BACKGROUND OF THE INVENTION

1. Field of the Invention

The present invention relates to a wireless base station, and more particularly, to an apparatus and a method for compensating phase errors in a wireless base station system, which can compensate I/Q (In-phase/Quadrature) signal imbalances and phase errors occurring in base station systems each having a direct conversion transmitter according to the respective systems as well as continuously monitor and compensate the degree of the I/Q signal imbalances through its own feedback path.

2. Description of the Related Art

In general, a mobile communication system includes a Mobile Switching Center (MSC), a Base Station System (BSS) and a Mobile Station (MS).

The BSS may include a Base Station Controller (BSC) and a Base Station Transceiver System (BTS) that is wired with the BSC so that the BTS can communicate with the BSC.

The BSS executes wireless communication with the MS, and is connected with a Public Switched Telephone Network (PSTN) so that the MS can communicate with the PSTN.

Mobile communication systems as above can be classified into the Digital Cellular System (DCS), the Personal Communication System (PCS) and the International Mobile Telecommunication 2000 (IMT-2000) according to the frequency range.

The mobile communication systems can be classified according to various standards. As a representative instance, the mobile communication systems can be classified according to transmission frequency ranges. For example, the Digital Cellular System (DCS) is allocated with a transmission frequency range of 869 to 894 MHz, the Personal Communication System (PCS) is allocated with a transmission frequency range of 1840 to 1870 MHz, and the International Mobile Telecommunication 2000 (IMT-2000) system is allocated with a transmission frequency range of 2110 to 2170 MHz.

Early stage base station systems were designed to support only one communication type, but current base station systems are designed in view of supporting a plurality of communication types. In order to satisfy such a trend, transceiver (TRXA) blocks of a BTS are necessarily designed to support Frequency Assignments (FA) according to the respective communication types. Simply, the BTS is designed to have all the transceiver (TRXA) blocks supporting the respective communication types.

### SUMMARY OF THE INVENTION

It is, therefore, an object of the invention to provide an apparatus and a method for compensating phase errors in a wireless Base Station System (BSS), which can compensate I/Q signal imbalances and phase errors occurring in base station systems each having a direct conversion transmitter according to the respective systems as well as continuously monitor and compensate the degree of the I/Q signal imbalances through its own feedback path in order to overcome phase distortion and I/Q signal imbalance occurring at RF (radio-frequency) terminals of the respective wireless base station systems each having a direct conversion transmitter, thereby ensuring phase linearity to the base station systems using the direct conversion transmitter while improving its performance.

According to an aspect of the apparatus for compensating phase errors in a wireless BSS according to the invention for realizing the above object, there is provided an RF transmission apparatus in a wireless BSS comprising: phase compensation unit for measuring unique phase errors of RF transmission signals based upon I and Q modulation signals for RF signals at the setup of a phase error compensation mode and compensating phases of the RF transmission signals based upon difference values between the measured phase errors and phase compensation values that are previously compensated; and power detecting unit for converting the input I and Q signals from the phase compensation unit into RF transmission signals, detecting power values for the converted RF signals and modulating the detected power values to provide the modulated I and Q signals to the phase compensation unit.

Preferably, the phase-compensation unit include: a signal generator for generating I and Q signals corresponding to a unique phase of the system according to an input frequency and providing the I and Q signals to the power-detecting unit; and a controller for setting phase error compensation and normal operation modes, inputting a frequency to the signal generator at the phase error compensation mode, calculating differences between the modulated I and Q signals from the power-detecting unit and I and Q compensation values that are previously compensated to store calculated compensation values, and compensating phases of source I and Q signals to be transmitted, at conversion from the phase error compensation mode into the normal mode, based upon the stored compensation value.

Preferably, the controller includes: at least one mode switch for setting the phase error compensation mode and the normal operation mode; and an adder for adding the stored compensation values to the source I and Q signals, respectively.

Preferably, the controller provides the modulated I and Q signals from the power-detecting unit, averages the provided I and Q signals for a predetermined time period, and calculates differences from the I and Q compensation values that are previously compensated in order to calculate the compensation values.

The RF transmission apparatus may further comprise an interpolator for interpolating the phase-compensated I and Q signals, which are added by the adder, and providing the interpolated I and Q signals to the power-detecting unit.

Preferably, the controller sets a predetermined time period and controls the phase compensation mode and the normal operation mode to convert into each other according to the set time period.

Preferably, the power-detecting unit include: a first RF processor for modulating the I and Q signals from the phase-compensation unit and converting up the modulated signals to a set frequency of RF signals to be transmitted via an antenna; and a second RF processor for detecting RF power values of the RF signals, which are processed by the first RF processor, modulating the detected RF power values into I and Q signals, converting down the modulated I and Q signals into a predetermined frequency to be provided as reference signals for phase compensation to the phase-compensation unit.

Preferably, the first RF processor includes: an A/D converter for converting the I and Q signals from the phase-compensation unit into analog I and Q signals; a modulator for quadrature-modulating the analog I and Q signals from the A/D converter and converting up the quadrature-modulated I and Q signals to a target frequency; a power amplifier for amplifying the up-converted signals from the modulator to a predetermined level and transmitting the amplified signals via the antenna; and a phase locked loop circuit (PLL) for providing a PLL frequency for the up-conversion by the modulator.

Preferably, the second RF processor includes: a detector for detecting power values of the RF signals that are processed by the first processor; a modulator for quadrature-modulating the power values from the detector into I and Q signals and converting down the quadrature-modulated I and Q signals into a predetermined frequency; and an A/D converter for converting the down-converted I and Q signals from the modulator into digital signals to be provided to the phase-compensation unit.

According to another aspect of the apparatus for compensating phase errors in a wireless BSS according to the invention for realizing the above object, there is provided an RF transmission apparatus in a wireless BSS comprising: phase compensation unit for measuring unique phase errors of RF transmission signals based upon I and Q modulation signals for RF signals at the setup of a phase error compensation mode and compensating phases of the RF transmission signals based upon difference values between the measured phase errors and phase compensation values that are previously compensated; and power detecting unit for converting the input I and Q signals from the phase compensation unit into RF transmission signals, detecting power values for the converted RF signals and modulating the detected power values to provide the modulated I and Q signals to the phase compensation unit, wherein the phase-compensation unit include: a signal generator for generating I and Q signals corresponding to a unique phase of the system according to an input frequency and providing the I and Q signals to the power-detecting unit; and a controller for setting phase error compensation and normal operation modes, inputting a frequency to the signal generator at the phase error compensation mode, calculating differences between the modulated I and Q signals from the power-detecting unit and I and Q compensation values that are previously compensated to store calculated compensation values, and compensating phases of source I and Q signals to be transmitted, at conversion from the phase error compensation mode into the normal mode, based upon the stored compensation value.

According to another aspect of the method for compensating phase errors in a wireless BSS according to the invention for realizing the above object, there is provided a method for transmitting RF signals in a wireless Base Station System (BSS), the method comprising the steps of: if a phase error compensation mode is set, detecting power value of RF signals transmitted via an antenna, I/Q modulating a power value of a detected neighboring channel, and providing modulated I and Q signals as reference signals for phase compensation; and measuring unique phase errors of the RF transmission signals according to the I and Q modulation signals and compensating phases of the RF transmission signals based upon the differences between measured error values and phase compensation values that are previously compensated.

Preferably, the phase compensating step comprises: generating I and Q signals corresponding to system's unique phase according to an input frequency; and setting phase error compensation and normal operation modes, calculating differences of I and Q signals modulated at the error compensation mode from I and Q compensation values that are previously compensated to store the I and Q compensation values, and compensating phases of source I and Q signals to be transmitted, at conversion of the phase error compensation mode into the normal operation mode, based upon the stored compensation values.

Preferably, the calculating step comprises providing the modulated I and Q signals from the power-detecting step, averaging the provided I and Q signals for a predetermined time period, and calculating differences from the I and Q compensation values that are previously compensated.

Preferably, the mode conversion is controlled by setting a time period so that the phase compensation mode and the normal operation mode convert into each other according to the set time period.

Preferably, the step of providing modulated I and Q signals as reference signals comprises: modulating provided I and Q signals to be transmitted via the antenna, converting up the modulated I and Q signals into a set frequency of RF signals, and transmitting the up-converted RF signals; detecting the RF power of the RF signals, modulating the detected RF signals into I and Q signals, converting down the modulated I and Q signals of a predetermined frequency, and providing the down-converted I and Q signals as reference signals for the phase compensation.

Preferably, the step of providing the down-converted I and Q signals as reference signals for the phase compensation comprises: detecting power values of RF signals transmitted via the antenna; quadrature-modulating the detected power values into I and Q signals and converting down the quadrature-modulated I and Q signals of a predetermined frequency; and digitalizing the down-converted I and Q signals and providing the digital I and Q signals as reference signals for phase compensation.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram illustrating an RF processing unit in a wireless BSS; and

FIG. 2 is a block diagram illustrating an apparatus for compensating phase errors in a wireless BSS according to the invention.

### DETAILED DESCRIPTION OF THE PREFERRED EMBODIMENTS

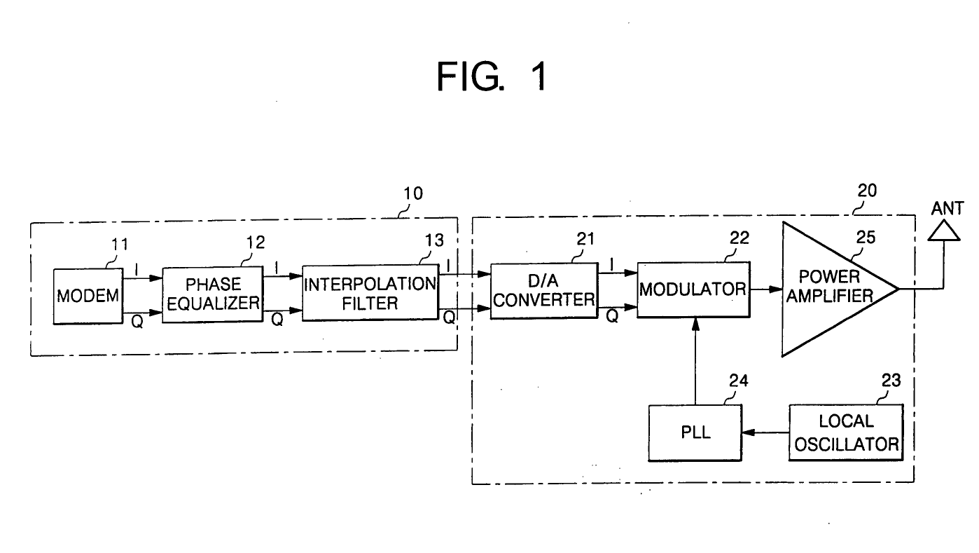

FIG. 1 is a block diagram illustrating an RF processing unit in a conventional wireless BSS.

As shown in FIG. 1, a transmission unit of the wireless BSS is generally divided into a digital signal processing unit 10 and an RF processing unit 20.

The digital signal processing unit 10 may include a modem 11, a phase equalizer 12 and an interpolation filter 13.

The RF processing unit 20 may include a D/A (digital-to-analog) converter 21, a modulator 22, a local oscillator 23, a phase locked loop (PLL) circuit or PLL 24 and a power amplifier 25 connected to an antenna ANT.

When the modem 11 of the digital signal processing unit 10 outputs digital I and Q signals, the phase equalizer 12 executes group delay compensation to convert the digital I and Q signals into I and Q baseband signals, which are in turn sent to the interpolation filter 13.

The interpolation filter 13 interpolates the I and Q baseband signals from the phase equalizer 12 to raise sampling rates for the I and Q baseband signals before sending the I and Q signals to the D/A converter 21 of the RF processing unit 20.

The D/A converter 21 of the RF processing unit 20 converts the I and Q signals from the digital signal processing unit 10 into analog signals, and sends the analog I and Q signals into the modulator 22.

The modulator 22 performs quadrature modulation to the I and Q signals from the D/A converter 21, and converts the modulated I and Q signals up to a desired RF frequency by using a PLL frequency provided from the PLL 24.

The up-converted RF signals are amplified to a specific level through the power amplifier 25, and then transferred via the antenna ANT to the air.

In a front terminal of the antenna, there is installed a duplexer (not shown) which functions to separate a transmission signal Tx from a receiving signal Rx in case that a single antenna is used. The duplexer will not be further described since it is not closely associated with the invention.

The local oscillator 23 provides a reference RF frequency to the PLL 24, which generates an RF frequency of a desired band by using the reference RF frequency from the local oscillator 23 and then sends the RF frequency of the desired band to the modulator 22.

The direct conversion transmitter adopted to the wireless BTS as above has advantages such as simple structure and efficient power consumption over a typical heterodyne transmitter, but has a problem of I/Q imbalance in output signals originated from non-linearity, gain imbalance, phase error, DC power offset, and so on, in a power amplifier at an RF terminal.

There are various schemes such as feedforward, feedback and predistortion have been proposed to solve this problem, but they have their own drawbacks together with advantages and thus can be hardly applied to actual products.

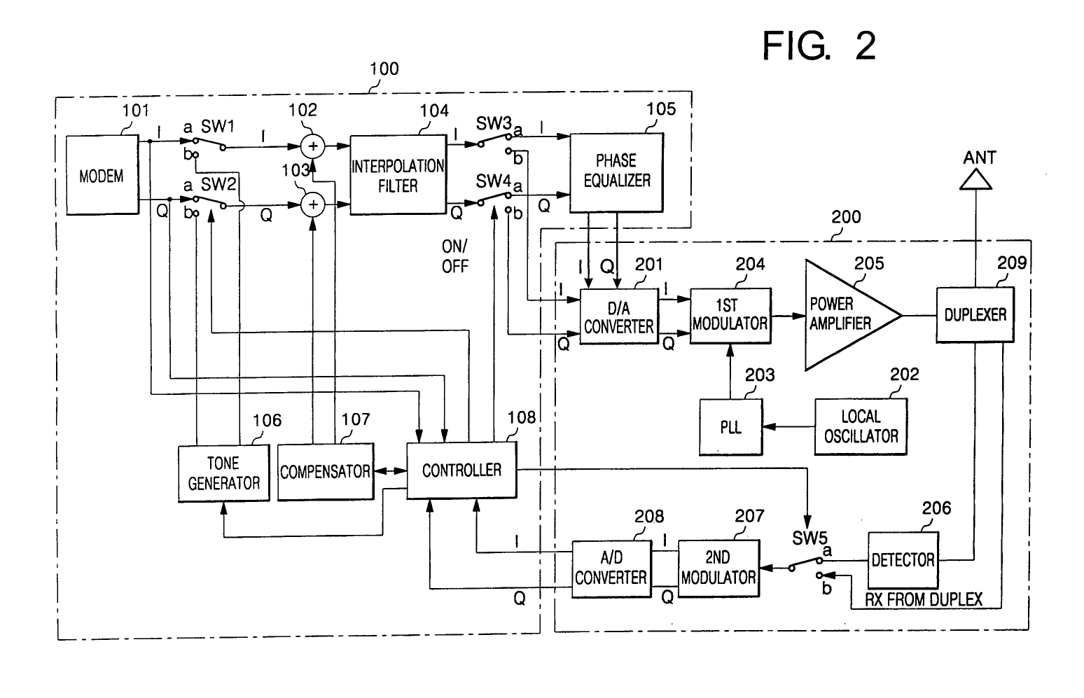

Hereinafter a preferred embodiment of an apparatus and method for compensating phase errors in a wireless Base Station System (BSS) according to the invention will be described in detail with reference to FIG. 2.

FIG. 2 is a block diagram illustrating an apparatus for compensating phase errors in a wireless BSS according to the invention.

As shown in FIG. 2, the phase error-compensating apparatus of the invention is generally constituted of a digital signal processing unit 100 and an RF processing unit 200.

The digital signal processing unit 100 includes a modem 101, switches SW1 to SW4, adders 102 and 103, an interpolation filter 104, a phase equalizer 105, a tone generator 106, a compensator 107 and a controller 108.

The RF processing unit 200 includes a D/A converter 201, a local oscillator 202, a phase locked loop (PLL) circuit or PLL 203, first and second modulators 204 and 207, a power amplifier 205, a detector 206, an A/D (analog-to-digital) converter 208, a duplexter 209 and an antenna ANT.

That is, the phase error-compensating apparatus of the invention includes the tone generator 106 for generating tone signals of specific frequencies, the interpolation filter 104, the compensator 107 for adding compensation values calculated by the controller 108 to I and Q output signals from the modem 101, the controller 108 for calculating the phase difference between final RF output terminal signals and source signals, the phase equalizer 105, the A/D converter 208 for converting power values of transmission RF signals detected by the detector 206 into digital signals, the D/A converter 201, the first modulator 204, the PLL 203, the local oscillator 202, the power amplifier 205, the detector 206 for detecting the RF transmission power values, the duplexer 209 and the second modulator 207.

The operation of the apparatus for compensating phase errors in a wireless BSS of the invention as above will be now described in detail with reference to the accompanying drawing.

Hereinafter the operation of the invention will be categorized into two parts.

First, it will be described about an initial setup process of the wireless BSS.

The invention needs an initial setup process in order to measure and compensate unique phase imbalance and phase error of a corresponding system. For this purpose, the invention uses the tone generator 106 in the digital signal processing unit 100 in FIG. 2.

When the controller 108 inputs a suitable frequency value to the tone generator 106, the tone generator 106 generates tone signals corresponding to the input frequency.

When the controller 108 inputs the suitable frequency value to the tone generator 106 to enable the same, the switches 1 and 2 are switched to their respective b terminals. Therefore, the switches 1 and 2 are disconnected from the modem 101, and a source is converted to the tone generator 106. That is, tone signals from the tone generator 106 are provided via the switches SW1 and SW2 to the adders 102 and 103, respectively.

Simultaneously with the disconnection of the switches SW1 and SW2 from the modem 101, the controller 108 connects the switches SW3 and SW4 with their respective b terminals also, so that the tone signals from the tone generator 106 can be bypassed to the D/A converter 201 of the RF processing unit 200 without passing through the phase equalizer 105.

The phase equalizer 105 serves to compensate the group delay of a signal. If tone signals from the tone generator 106 are passed through the phase equalizer 105, it is difficult to properly measure unique phase imbalance and phase error of the system.

Therefore, in order to measure the unique phase imbalance and phase error, the invention outputs the tone signals from the tone generator 106 as RF signals via the adders 102 and 103, the interpolation filter 104, the D/A converter 201, the first modulator 204 and the power amplifier 205. The detailed description of this process will be rendered later in the specification.

Then, the output RF signals are observed with a spectrum analyzer (not shown) to measure and compensate the unique phase imbalance and phase error of the system.

In the compensation process, the controller 108 controls the compensator 107 to add or subtract compensation values to I and Q digital values with the adders 102 and 103 thereby to adjust the phase imbalance or phase error. The compensation process for the phase imbalance and phase error will be described detail later by using equations below.

The controller 108 stores the compensation values for the I and Q digital values, which are obtained with the spectrum analyzer, in a memory (not shown) thereof as unique compensation values.

The compensation values of the system are first stored with reference to the spectrum analyzer because products obtained according to the invention are compensated to a predetermined degree based upon system's unique compensation values and then I/Q imbalances and phase errors are corrected in the operation of the system unlike to the foregoing explanation. That is, the RF system is periodically measured by using the initial compensation values as reference values to add or subtract offset values to the reference values so that the RF system can be maintained in the s5 optimum condition regardless of influences such as temperature, variation in power and aging.

A process of compensating the I and Q imbalance and phase errors in the operation of the system will be now described.

Under the control of the controller 108, the system is converted into a normal operation mode and an error detection and compensation mode during the operation thereof.

That is, the switches SW1 to SW4 are normally connected to their respective a terminals, and at a preset time of the system, the controller 108 sends switching control signals to the switches SW1 to SW4 converting the switches SW1 to SW4 to their respective b terminals so that the system is converted into the error detection mode.

Further, after controlling the switches to convert the system to the error detection mode, the controller 108 inputs predetermined frequencies into the tone generator 106 to generate tone signals of specific frequencies. As a consequence, the tone generator 106 generates the tone signals corresponding to the input frequencies under the control of the controller 108 and sends the tone signals to the adders 102 and 103.

The tone signals from the tone generator 106 are sent via the adders 102 and 103 to the interpolation filter 104.

The interpolation filter 104 samples the input I and Q signals to raise a sampling rate, and sends the I and Q signals via the switches SW3 and SW4 to the D/A converter 201.

The D/A converter 201 converts the I and Q signals received from the interpolation filter 104 via the switches SW3 and SW4 into analog signals, respectively, and sends the I and Q analog signals to the first modulator 204.

The first modulator 204 quadrature-modulates the I and Q analog signals sent from the D/A converter 201, converts the quadrature-modulated I and Q analog signals up to target RF frequencies by using PLL frequencies from the PLL 203, and sends the up-converted RF signals via the power amplifier 205 to the duplexer 209.

Simultaneously, the RF signals from the power amplifier 205 are returned as feedback signals via the duplexer 209 to the detector 206. The detector 206 measures the intensity of power of a neighboring channel by using the RF feedback signals, and then provides the measured power intensity to the second modulator 207 via the switch SW5. That is, because the I/Q imbalance and phase errors not only influence the current transmission channel of the I/Q signals but also raise the noise level of a frequency bandwidth neighboring the transmission channel, the detector 206 is operated to measure the noise level and thus minimize the power of a neighboring channel.

The signals detected by the detector 206 are input into the second modulator 207 via the switch SW5, and the second modulator 207 modulates and converts the input signals from the detector 206 into baseband signals of divided I and Q signals, which are in turn sent to the A/D converter 208.

The A/D converter 208 converts the modulated I and Q signals from the second modulator 207 into digital signals, and sends the digital signals to the controller 108.

The controller 108 quadrature-modulates the I and Q digital signals from the A/D converter 208 to make averages for a predetermined time period. Then, the controller 108 calculates difference values from the previously stored compensation values, judges whether to quadrature-modulate the calculated values, and sends a control signal for phase error compensation to the compensator 107.

A method of judging I/Q imbalance values for the neighboring channel power will be described by using Equations below.

After compensating the phase error and the phase imbalance as above, the controller 108 sends switching control signals to the switches SW1 to SW5 to convert the switches SW1 to SW5 to terminals a so that the error detection and compensation mode is converted to the normal operation mode.

The second modulator 207 shown in FIG. 2 can be used to receive RF signals or detect and compensate errors through the operation of the switch SW5. The phase error detection and compensation time may be set so that the system operates for about 10 ms or less. Alternatively, a system operator may determine a time period in which the system is rarely operated as the phase error detection and compensation time.

Hereinafter a method for compensating phase differences by detecting tone signals of a predetermined frequency input via a transmission path with the detector 206 and then dividing the detected signals again into I and Q signals to detect phase differences will be described by using Equations below.

If signals generated from the tone generator 106 satisfy Equation 1 below, detected feedback signals will be expressed as Equation 2 below:
I(t)=cos(wt)
Q(t)=sin(wt) Equation 1, and
I′(t)=Acos(wt)+Bi
Q′(t)=sin(wt+θ)+Bq Equation 2,
wherein A indicates magnitude error, Bi and Bq indicate DC biases, respectively, and θ indicates phase error.

Assumed that Bi is an average of I′(t) for a predetermined period, Bi and Bq are subtracted from average values of signals in I and Q paths, respectively. Distorted signals can be defined as in Equation 3 below:
I″(t)=Acos(wt)
Q″(t)=sin(wt+θ) Equation 3.

Equation 3 above can be defined into a matrix as expressed in Equation 4 below:

$$[ \begin{matrix}{I}^{′′} ( t ) \\ {Q}^{′′} ( t )\end{matrix} ] = [ \begin{matrix}A & 0 \\ sin ( θ ) & cos ( θ )\end{matrix} ] \times [ \begin{matrix}I ( t ) \\ Q ( t )\end{matrix} ] . \qquad Equation 4$$

Further, the matrix of Equation 4 will be processed into an inverse matrix as expressed in Equation 5 below:

$$[ \begin{matrix}I ( t ) \\ Q ( t )\end{matrix} ] = [ \begin{matrix}1 / A & 0 \\ ( 1 / A ) tan ( θ ) & sec ( θ )\end{matrix} ] \times [ \begin{matrix}{I}^{′′} ( t ) \\ {Q}^{′′} ( t )\end{matrix} ] . \qquad Equation 5$$

If definition is made as in Equation 6 below in order to calculate A in Equation 5 above, Equation 3 can be defined as Equation 7 as below:

$$[ x ( t ) ] = \frac{1}{NT} {\int }_{t - NT}^{t} x ( u ) ⅆ u . \qquad Equation 6$$

wherein T indicates 2Kπ/w, K indicates an integer, and N indicates an integer other than 0, and
Z[I″(t)I″(t)]=A2[cos 2(wt)]=(½)A2,
[I″(t)Q″(t)]=(½)A2 sin(θ) Equation 7.

Therefore, the value of A can be obtained from (½)A2 in Equation 7 above, and the value of θ can be obtained from (½)A2 sin(θ). That is, A and θ can be obtained as in Equation 8 below:
A=√/(2[I″(t)I″(t)]),
sin(θ)=(2/A)[I″(t)Q″(t)],
cos(θ)=√(1−sin 2(wt)) Equation 8

These values obtained as above are stored in a memory of the controller to be used as reference values in the compensation of errors.

After initial storage of unique error values of the system, the error values are used together with the offset values in real time compensation, in which signals are received from the modem 101. Further, the controller 108 calculates A and θ using Equations above.

The tone signals applied by the tone generator 106 are adapted to bypass the phase equalizer 105 to avoid intentional phase change by the phase equalizer 105.

In the meantime, the phase equalizer 105 shown in FIG. 2 is arranged at the distal terminal of the digital signal processing unit 100 to prevent hardware-induced signal delay associated with filter constitution at each terminal or delay induced from a multiplier structure, occurring from various programmable logics (FPGA) of the digital signal processing unit 100, or phase displacement occurring from the reconstitution of the front terminal of the signal processing unit, thereby ensuring independency in system constitution.

As set forth above, the apparatus and method for compensating phase errors in a wireless BSS according to the invention provides a structure for preventing the phase imbalance, as one of problems that habitually occurring in the direct conversion transmitter. The invention can compensate unique phase error of a system at shipment, find any deflection or problem of parts occurring in the manufacture thereof, and continuously compensate phases during the operation of the system so as to assist system stabilization.

As a consequence, the present invention can compensate I/Q signal imbalances and phase errors occurring in base station systems each having a direct conversion transmitter according to the respective systems as well as continuously monitor and compensate the degree of the I/Q signal imbalances through its own feedback path in order to overcome phase distortion and I/Q signal imbalance occurring at RF terminals of the respective wireless base station systems each having a direct conversion transmitter, thereby ensuring phase linearity to the base station systems using the direct conversion transmitter while improving its performance.

1. A radio frequency (RF) transmission apparatus in a wireless Base Station System (BSS) comprising:
a phase compensation unit for measuring unique phase errors of RF transmission signals based upon I (in-phase) and Q (quadrature) modulation signals for RF signals at initial setup of a phase error compensation mode and compensating phases of the RF transmission signals based upon difference values between measured phase errors and phase compensation values that are previously compensated; and
a power detecting unit for converting the input I and Q signals from the phase compensation unit into RF transmission signals, detecting power values for the converted RF signals and modulating the detected power values to provide the modulated I and Q signals to the phase compensation unit.

2. The apparatus according to claim 1, wherein the phase-compensating unit measures and stores the phase error compensation values as initial values at initial phase error compensation mode setup, and use the stored initial values as reference values to calculate differences from phase error compensation values measured at subsequent phase error compensation mode setup.

3. The apparatus according to claim 1, wherein the phase-compensating unit include:
a signal generator for generating I and Q signals corresponding to a unique phase of the system according to an input frequency and providing the I and Q signals to the power-detecting unit; and
a controller for setting phase error compensation and normal operation modes, inputting a frequency to the signal generator at the phase error compensation mode, calculating differences between the modulated I and Q signals from the power-detecting unit and I and Q compensation values that are previously compensated to store calculated compensation values, and compensating phases of source I and Q signals to be transmitted, at conversion from the phase error compensation mode into the normal mode, based upon the stored compensation value.

4. The apparatus according to claim 3, wherein the controller includes:
at least one mode switch for setting the phase error compensation mode and the normal operation mode; and
an adder for adding the stored compensation values to the source I and Q signals, respectively.

5. The apparatus according to claim 3, wherein the controller provides the modulated I and Q signals from the power-detecting unit, averages the provided I and Q signals for a predetermined time period, and calculates differences from the I and Q compensation values that are previously compensated in order to calculate the compensation values.

6. The apparatus according to claim 4, further comprising an interpolator for interpolating the phase-compensated I and Q signals, which are added by the adder, and providing the interpolated I and Q signals to the power-detecting unit.

7. The apparatus according to claim 3, wherein the controller sets a predetermined time period and controls the phase compensation mode and the normal operation mode to convert into each other according to the set time period.

8. The apparatus according to claim 1, wherein the power-detecting unit include:
a first RF processor for modulating the I and Q signals from the phase-compensating unit and converting up the modulated signals to a set frequency of RF signals to be transmitted via an antenna; and
a second RF processor for detecting RF power values of the RF signals, which are processed by the first RF processor, modulating the detected RF power values into I and Q signals, converting down the modulated I and Q signals into a predetermined frequency to be provided as reference signals for phase compensation to the phase-compensation unit.

9. The apparatus according to claim 8, wherein the first RF processor includes:
an A/D converter for converting the I and Q signals from the phase-compensation unit into analog I and Q signals;
a modulator for quadrature-modulating the analog I and Q signals from the A/D converter and converting up the quadrature-modulated I and Q signals to a target frequency;
a power amplifier for amplifying the up-converted signals from the modulator to a predetermined level and transmitting the amplified signals via the antenna; and
a phase locked loop circuit (PLL) for providing a phase locked loop circuit (PLL) frequency for the up-conversion by the modulator.

10. The apparatus according to claim 8, wherein the second RF processor includes:
a detector for detecting power values of the RF signals that are processed by the first processor;
a modulator for quadrature-modulating the power values from the detector into I and Q signals and converting down the quadrature-modulated I and Q signals into a predetermined frequency; and
an A/D converter for converting the down-converted I and Q signals from the modulator into digital signals to be provided to the phase-compensation unit.

11. An apparatus in a wireless Base Station System (BSS) comprising:
phase compensation unit for measuring unique phase errors of radio frequency (RF) transmission signals based upon I (in-phase) and Q (quadrature) modulation signals for RF signals at the setup of a phase error compensation mode and compensating phases of the RF transmission signals based upon difference values between the measured phase errors and phase compensation values that are previously compensated; and
power detecting unit for converting the input I and Q signals from the phase compensation unit into RF transmission signals, detecting power values for the converted RF signals and modulating the detected power values to provide the modulated I and Q signals to the phase compensation unit, wherein the phase-compensation unit include: a signal generator for generating I and Q signals corresponding to a unique phase of the system according to an input frequency and providing the I and Q signals to the power-detecting unit; and
a controller for setting phase error compensation and normal operation modes, inputting a frequency to the signal generator at the phase error compensation mode, calculating differences between the modulated I and Q signals from the power-detecting means and I and Q compensation values that are previously compensated to store calculated compensation values, and compensating phases of source I and Q signals to be transmitted, at conversion from the phase error compensation mode into the normal mode, based upon the stored compensation value.

12. The apparatus according to claim 11, wherein the controller includes:
at least one mode switch for setting the phase error compensation mode and the normal operation mode; and
an adder for adding the stored compensation values to the source I and Q signals, respectively.

13. The apparatus according to claim 12, wherein the controller provides the modulated I and Q signals from the power-detecting unit, averages the provided I and Q signals for a predetermined time period, and calculates differences from the I and Q compensation values that are previously compensated in order to calculate the compensation values.

14. The apparatus according to claim 12, further comprising an interpolator for interpolating the phase-compensated I and Q signals, which are added by the adder, and providing the interpolated I and Q signals to the power-detecting means.

15. A method for transmitting radio frequency (RF) signals in a wireless Base Station System (BSS), the method comprising the steps of:
when a phase error compensation mode is set, detecting power value of RF signals transmitted via an antenna, I/Q (in-phase/quadrature) modulating a power value of a detected neighboring channel, and providing modulated I (in-phase) and Q (quadrature) signals as reference signals for phase compensation; and
measuring unique phase errors of the RF transmission signals according to the I and Q modulation signals and compensating phases of the RF transmission signals based upon the differences between measured error values and phase compensation values that are previously compensated.

16. The method according to claim 15, wherein the step of providing the I and Q signals as the reference signals comprises measuring phase error compensation values at initial phase error compensation mode setup and storing the phase error compensation values as initial reference values for calculating difference values from subsequent phase error compensation values measured at subsequent phase error compensation mode setup.

17. The method according to claim 15, wherein the phase compensating step comprises:
generating I and Q signals corresponding to system's unique phase according to an input frequency; and
setting phase error compensation and normal operation modes, calculating differences of I and Q signals modulated at the error compensation mode from I and Q compensation values that are previously compensated to store the I and Q compensation values, and compensating phases of source I and Q signals to be transmitted, at conversion of the phase error compensation mode into the normal operation mode, based upon the stored compensation values.

18. The method according to claim 17, wherein the calculating step comprises providing the modulated I and Q signals from the power-detecting step, averaging the provided I and Q signals for a predetermined time period, and calculating differences from the I and Q compensation values that are previously compensated.

19. The method according to claim 17, wherein the mode conversion is controlled by setting a time period so that the phase compensation mode and the normal operation mode convert into each other according to the set time period.

20. The method according to claim 15, wherein the step of providing modulated I and Q signals as reference signals comprises:
modulating provided I and Q signals to be transmitted via the antenna, converting up the modulated I and Q signals into a set frequency of RF signals, and transmitting the up-converted RF signals; and
detecting the RF power of the RF signals, modulating the detected RF signals into I and Q signals, converting down the modulated I and Q signals of a predetermined frequency, and providing the down-converted I and Q signals as reference signals for the phase compensation.

21. The method according to claim 20, wherein the step of providing the down-converted I and Q signals as reference signals for the phase compensation comprises:
detecting power values of RF signals transmitted via the antenna;
quadrature-modulating the detected power values into I and Q signals and converting down the quadrature-modulated I and Q signals of a predetermined frequency; and
digitalizing the down-converted I and Q signals and providing the digital I and Q signals as reference signals for phase compensation.
